(19) United States
(12) Patent Application Publication
(10) Pub. No.: US 2025/0196791 A1
(43) Pub. Date: Jun. 19, 2025

(54) OUT-OF-CABIN VOICE CONTROL OF FUNCTIONS OF A PARKED VEHICLE

(71) Applicant: Analog Devices International Unlimited Company, Limerick (IE)

(72) Inventor: Dietmar RUWISCH, Berlin (DE)

(21) Appl. No.: 18/846,208

(22) PCT Filed: Mar. 10, 2023
(86) PCT No.: PCT/EP2023/056255

§ 371 Date: Sep. 11, 2024

Related U.S. Application Data
(60) Provisional application No. 63/318,966, filed on Mar. 11, 2022.

(51) Int. Cl. B60R 16/037; B60Q 1/50

(52) U.S. Cl. CPC B60R 16/0373; B60Q 1/543

(57) ABSTRACT

Technologies are provided for out-of-cabin voice control of functions of a parked vehicle. In some aspects, the technologies include an electronic device that can transition, in response to a first presence signal from a power-off state to a power-on state while a vehicle is parked, wherein the device is integrated into the vehicle. The electronic device also can determine, in response to a second presence signal, that an entity is within a defined range from the vehicle and approaching the vehicle. The electronic device can further receive, from a microphone integrated into the vehicle, an audio signal representative of speech. The electronic device can determine, using the audio signal, that a defined command is present in the speech. The electronic device can then cause an actor device to perform an operation corresponding to the command. Performing the operation causes a change in a state of the vehicle.

### CROSS-REFERENCE TO RELATED APPLICATION

This application is a 35 U.S.C. § 371 National Stage Application of International Patent Application No. PCT/EP2023/056255, filed Mar. 10, 2023, which application claims the benefit of and priority to U.S. Provisional Patent Application No. 63/318,966, filed on Mar. 11, 2022, the contents of each of which applications are hereby incorporated by reference herein in their entireties.

### BACKGROUND

Voice control of various functions of a vehicle can be achieved using speech uttered within a cabin of the vehicle. Some of those functions can be voice controlled in that fashion while the vehicle is in operation. Examples of those functions includes multimedia controls, navigation controls, heating, ventilation, and air conditioning (HVAC) controls, voice call controls, messaging controls, and illumination controls.

While voice control of functions of a vehicle in operation can provide comfort and safety during a trip in the vehicle, the reliance on speech uttered within the cabin of the vehicle can confine the voice control to functions unrelated to the setup of the trip. Yet, such a setup is an integral part of the trip itself. As such, commonplace voice control of vehicles fails to permit control of the entire travel experience in the vehicle, which ultimately may diminish the practicality of traveling in the vehicle or the versatility of the vehicle itself.

Therefore, much remains to be improved in technologies for voice control of functions of a parked vehicle.

### SUMMARY

One aspect includes a method that includes transitioning, in response to a first presence signal, an electronic device from a power-off state to a power-on state while a vehicle is parked, wherein the electronic device is integrated into the vehicle. The method also includes determining, in response to a second presence signal, that an entity is within a defined range from the vehicle and approaching the vehicle. The method may optionally further include causing, by the electronic device, a microphone integrated into the vehicle to transition from a power-off state to a power-on state. Alternatively, in some cases, the microphone may already be in the power-on state. The method still further includes receiving, from the microphone, an audio signal representative of speech; determining, by the electronic device, using the audio signal, that a defined command is present in the speech; and causing, by the electronic device, an actor device to perform an operation corresponding to the command, wherein performing the operation causes a change in a state of the vehicle.

Another aspect includes a device that includes at least one processor; and at least one memory device storing processor-executable instructions that, in response to execution by the at least one processor, cause the device to: transition, in response to a first presence signal from a power-off state to a power-on state while a vehicle is parked, wherein the device is integrated into the vehicle; determine, in response to a second presence signal, that an entity is within a defined range from the vehicle and approaching the vehicle; receive, from a microphone integrated into the vehicle, an audio signal representative of speech; determine, using the audio signal, that a defined command is present in the speech; and cause an actor device to perform an operation corresponding to the command, wherein performing the operation causes a change in a state of the vehicle.

Additional aspects include a vehicle including an electronic device configured to: transition, in response to a first presence signal from a power-off state to a power-on state while a vehicle is parked, wherein the device is integrated into the vehicle; determine, in response to a second presence signal, that an entity is within a defined range from the vehicle and approaching the vehicle; receive, from a microphone integrated into the vehicle, an audio signal representative of speech; determine, using the audio signal, that a defined command is present in the speech; and cause an actor device to perform an operation corresponding to the command, wherein performing the operation causes a change in a state of the vehicle.

This Summary is not intended to emphasize any particular aspects of the technologies of this disclosure. Nor is it intended to limit in any way the scope of such technologies. This Summary simply covers a few of the many aspects of this disclosure as a straightforward introduction to the more detailed description that follows.

### BRIEF DESCRIPTION OF THE DRAWINGS

The accompanying drawings form part of the disclosure and are incorporated into the subject specification. The drawings illustrate example aspects of the disclosure and, in conjunction with the following detailed description, serve to explain at least in part various principles, features, or aspects of the disclosure. Some aspects of the disclosure are described more fully below with reference to the accompanying drawings. However, various aspects of the disclosure can be implemented in many different forms and should not be construed as limited to the implementations set forth herein. Like numbers refer to like elements throughout.

FIG. 1 is a schematic diagram of out-of-cabin voice control of functions of a parked vehicle, in accordance with one or more aspects of this disclosure.

FIG. 2A is a block diagram of an example of a system for out-of-cabin voice control of a parked vehicle, in accordance with one or more aspects of this disclosure.

FIG. 2B is a block diagram of an example of another system for out-of-cabin voice control of a parked vehicle, in accordance with one or more aspects of this disclosure.

FIG. 3 is a block diagram of an example of a control device, in accordance with one or more embodiments of this disclosure.

FIG. 4A is a block diagram of an example of a system for out-of-cabin voice control of a parked vehicle, in accordance with one or more aspects of this disclosure.

FIG. 4B is a block diagram of an example of another system for out-of-cabin voice control of a parked vehicle, in accordance with one or more aspects of this disclosure.

FIG. 5 is a schematic diagram of an example of a system for out-of-cabin voice control of a parked vehicle, in accordance with one or more aspects of this disclosure.

FIG. 6 is a flowchart of an example of a method for controlling, using out-of-cabin speech, functionality of a vehicle that is parked, in accordance with one or more aspects of this disclosure.

FIG. 7 is a flowchart of an example of another method for controlling, using out-of-cabin speech, functionality of a vehicle that is parked, in accordance with one or more aspects of this disclosure.

### DETAILED DESCRIPTION

The present disclosure recognizes and addresses, among other technical challenges, the issue of controlling functions of a parked vehicle by using utterances from outside a cabin of the parked vehicle. Commonplace voice control of various functions of a vehicle can be achieved using speech uttered within a cabin of the vehicle. While voice control of functions of the vehicle in operation can provide comfort and safety during a trip in the vehicle, the reliance on speech uttered within the cabin of the vehicle can confine the voice control to functions unrelated to the setup of the trip. Accordingly, commonplace voice control of vehicles fails to permit control of the entire travel experience in the vehicle, which ultimately may diminish the practicality of traveling in the vehicle and/or the versatility of the vehicle itself.

As is described in greater detail below, aspects of the present disclosure include methods, electronic devices, and systems that, individually or collectively, permit voice control of functions of a vehicle by voice commands spoken outside the vehicle. Aspects of voice control described herein can use one or multiple microphones integrated into the vehicle. The microphone(s), in some cases, can be part of other subsystems present in the vehicle, e.g., for in-vehicle hands-free applications or road-noise cancellation applications. To reduce instances of false-positive voice recognition, speech recognition or, in some cases, keyword spotting, can be implemented when a subject associated with the vehicle is nearby and approaching the vehicle. By implementing voice recognition in such circumstances, the out-of-cabin voice control of the vehicle, in accordance with aspects of this disclosure, is energy efficient, drawing charge from energy storage integrated into the vehicle in situations that may result in a voice command being received by the vehicle, and not drawing charge at continually. Specifically, microphone(s) and an electronic device that implements detection of voice commands can be powered on in response to a subject associated with the vehicle being nearby and approaching the vehicle. In some cases, attenuation of the voice audio signal from outside to inside the vehicle can be compensated with an amplifier device and/or equalizer device that can be disabled if a window, a door, or the trunk of the vehicle is open.

In response to detecting a voice command in speech uttered outside the vehicle, an actor device integrated into the vehicle can be directed to perform an operation corresponding to the voice command. In some cases, a voice profile corresponding to the speech uttered outside the vehicle can be validated prior to causing the actor device to perform the operation corresponding to the defined command. In that way, execution of the voice command can be permitted for a subject that is sanctioned or otherwise whitelisted.

Aspects of this disclosure permit contactless voice control of a parked vehicle from the exterior of the vehicle, thus allowing straightforward setup of a trip in the vehicle. Such voice control is contactless in that it does not involve contact with vehicle prior to implementation of a voice command. In addition, or in some cases, voice control can be afforded exclusively to a sanctioned subject. Thus, impermissible control of the vehicle cannot be achieved. Avoiding impermissible control of the vehicle can be beneficial in many some scenarios. For example, in law enforcement, the vehicle can be a patrol car and one or several officers can be sanctioned to control the functions of that vehicle using out-of-cabin speech.

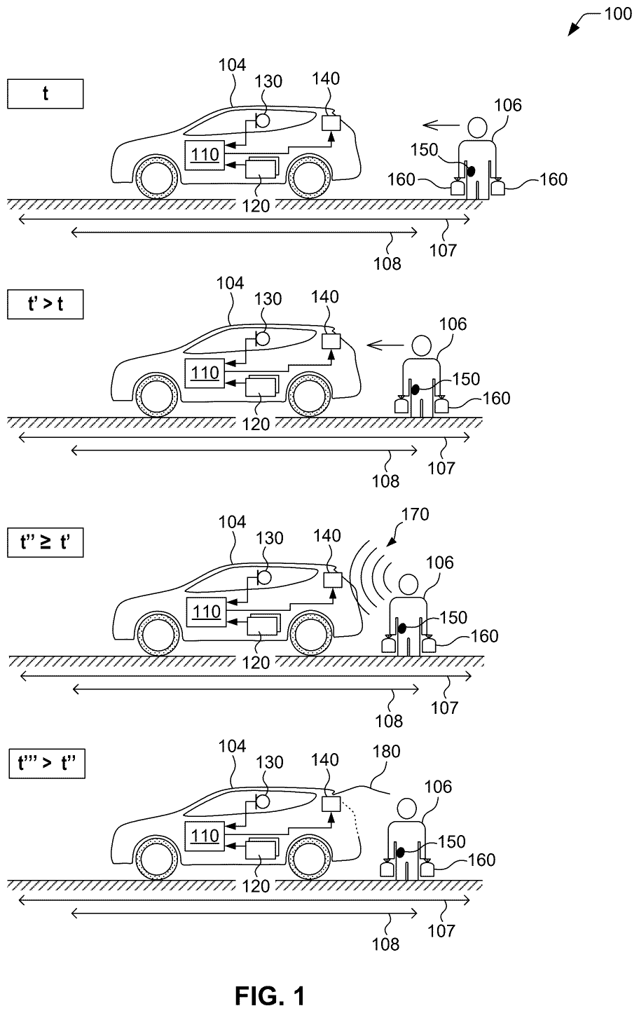

FIG. 1 is a schematic diagram 100 that illustrates a temporal progression of an example of voice control of operation of a vehicle 104 using speech from outside the cabin of the vehicle 104, in accordance with one or more aspects of this disclosure. While the vehicle 104 is depicted as a car, the disclosure is not limited in that respect and other types of vehicles, such farming equipment, also can implement and benefit from the out-of-cabin voice control in accordance with this disclosure. The vehicle 104 can be parked and a subject 106 can be approaching the vehicle 104. An arrow oriented towards the vehicle 104 represents movement of the subject 106 towards the vehicle 104. The subject 106 can be carrying hardware token 150 that can emits emit low-power electromagnetic (EM) radiation within a particular portion of the EM radiation spectrum (e.g., radiofrequency (RF) signals). The hardware token 150 can be embodied in, for example, a key fob having a transponder, a smartphone, or another type of portable device having circuitry to transmit low-power EM radiation. The hardware token 150 can emit the low-power EM radiation nearly continually or periodically, for example. As is illustrated in FIG. 1, in some cases, the subject 106 can have both hands occupied with objects 160 as the subject 106 approaches the vehicle 104.

The subject 106, and thus the hardware token 150, can reach a first range from the vehicle. For example, the subject 106 can reach the first range at a time t. The first range can correspond to a detection range 107 of a first detector device integrated into the vehicle 104. The first detector device can be part of multiple detector devices 120 that are integrated into the vehicle 104. The first detector device can sense RF signals (e.g., pilot signals) and/or other type of EM radiation emitted by the hardware token 150. The first detector device can be generically referred to as key fob detector.

Accordingly, the first detector device can sense the hardware token 150 and, in response, can generate a presence signal indicative of the hardware token 150 being within the detection range 107. The first detector device can supply (e.g., send or otherwise make available) the presence signal to a control device 110 integrated into the vehicle 104. The control device 110 is an electronic device that includes computing resources and other functional elements. The computing resources include, for example, one or several processors or processing circuitry, and one or more memory devices or storage circuitry. The control device 110 can have one of various form factors and constitutes an out-of-cabin voice control subsystem in accordance with aspects of this disclosure. In some cases, the control device 110 can be assembled in a dedicated package or board. In other cases, the control device 110 can be assembled in a same package or board of another subsystem present in the vehicle 104, e.g., a road-noise cancellation subsystem or an infotainment subsystem.

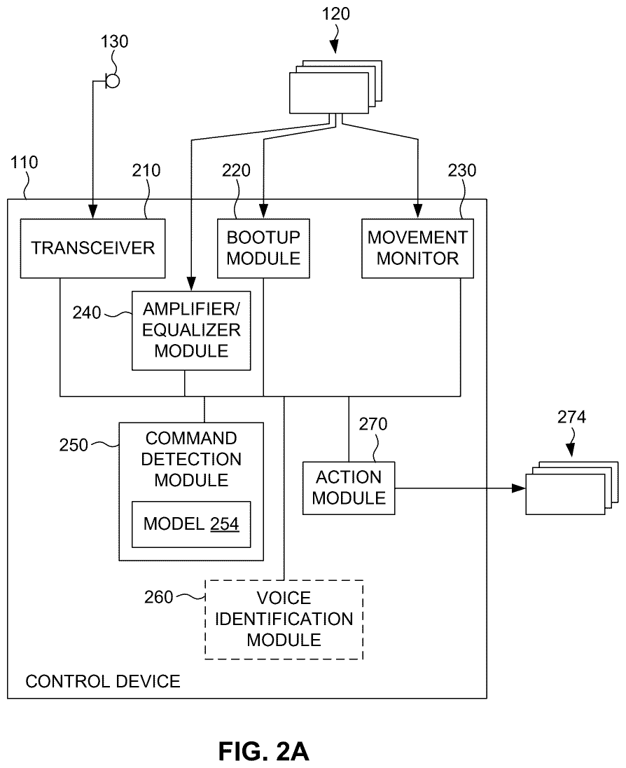

The control device 110 can receive the presence signal from the first detector device (e.g., one of the multiple detector devices 120). In response to receiving the presence signal, the control device 110 can bootup. That is, the presence signal can cause at least a portion of the control device 110 to transition from a power-off state to a power-on state. In some cases, as is shown in FIG. 2A, the control device 110 can include a bootup module 220 that can receive the presence signal and can energize the control device 110 in response to the presence signal. The control device 110 can be energized by drawing charge from energy storage (not depicted in FIG. 1) integrated into the vehicle 104, for example.

The control device 110 can monitor other presence signals corresponding to a second detector device integrated into the vehicle 104. For example, the second detector device can be part of a park-assist system and the other presence signals can be indicative of respective echoes of ultrasound waves. The second detector device can have a second detection range 108 that is less than the first detection range 107 of the first detector device. The second detection range 108 can be a distance of about 4 m to about 6 m, for example. Such presence signals can be indicative of an entity, such as the subject 106, being in proximity of the vehicle 104 and also approaching the vehicle 104. Accordingly, using those other presence signals, the control device 110 can determine if an entity (e.g., the subject 106) is in proximity to the vehicle 104 and/or approaching the vehicle 104. More specifically, reception, by the control device 110, of a presence signal from the second detector device can be indicative of the entity being at or within the second detection range 108. Hence, in response to receiving such a presence signal, the control device 110 can determine that the entity is in proximity of the vehicle 104. In other words, the entity is deemed in proximity to the vehicle 104—and, thus, the control device 110—in situations where the entity is at or within the second detection range. Conversely, lack of reception of such a presence signal at the control device 110 can be indicative of absence of an entity in proximity to the vehicle 104. In some cases, as is illustrated in FIG. 2A, the control device 110 can include a movement monitor module 230 that can receive present signals from the second detector device (a parking-assist device, for example). In response to receiving such presence signals, the movement monitor module 230 can determine that an entity is nearby and approaching the vehicle 104.

As is illustrated in FIG. 1, as the subject 106 continues approaching the vehicle 104, the control device 110 can determine that the subject 106 is in proximity of the vehicle 104 and approaching the vehicle 104. In such a situation, the subject can be within the second detection range 108. For example, to control device 110 can determine that the subject 106 is in proximity of the vehicle 140 and approaching the vehicle 104 at a time t′. The time t′ can be after the t. To determine that the subject 106 is in proximity of the vehicle 104 and approaching the vehicle 104, in some cases, the movement monitor 230 can receive a sequence of presence signals over time and, based on that sequence, the movement monitor 230 can determine that an entity (e.g., the subject 106) is approaching the vehicle. Signals in the sequence of presence signals can be temporally separated at increasingly shorter time intervals, which can be indicative of the entity approaching the vehicle 104. In response to such a determination, the control device 110 can energize (or power on) one or multiple microphones 130 integrated into the vehicle 104. To that point, the control device 110 can cause the microphone(s) 130 to transition from a power-off state to a power-on state. For example, the control device 110 can send an instruction, via the bootup module 220 (FIG. 2A), to the microphone(s) 130 to transition from the power-off state to the power-on state. The microphone(s) 130 can be energized by drawing charge from energy storage (not depicted in FIG. 1) integrated into the vehicle 104, for example. It is noted that the microphone(s) 130 can be energized at other times and/or by other mechanisms. For example, the microphones(s) 130 can be energized by the first detector device in response to detecting the hardware token 150. Alternatively, in some cases, the microphone(s) 130 may already be in the power-on state.

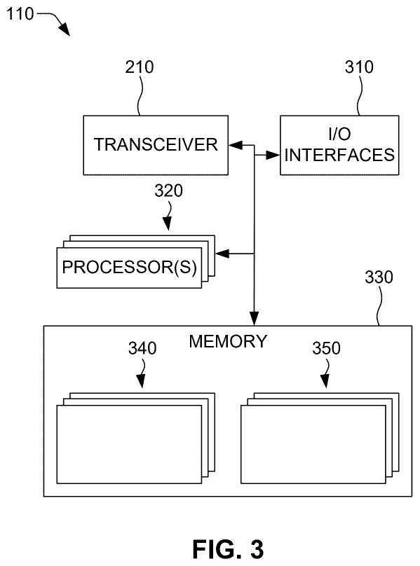

In some cases, the microphone(s) 130 can be present within a cabin of the vehicle 104. For example, the microphone(s) 130 can be mounted on a steering wheel or a seat assembly of the vehicle 104. In an example scenario where the microphone(s) 130 include multiple microphones, the microphones can be distributed across the cabin of the vehicle 104. In other cases, as is illustrated in FIG. 4A, the microphone(s) 130 can be assembled to the body of vehicle 104 and can be facing the exterior of the vehicle 104. The disclosure is, of course, not limited with respect to the placement of microphone(s). Indeed, as is illustrated in FIG. 4B, both cabin-mounted microphone(s) 130 and body-mounted microphone(s) 410 can be used in the implementation of the out-of-cabin voice control of a parked vehicle as is described herein.

At a time after at least one of the microphone(s) 130 has been energized, the control device 110 can receive an audio signal from the microphone(s) 130. For example, such a time can be a time t″ that can be after t′ or the same as t′. The audio signal can be representative of speech. The subject 106 can utter the speech outside the cabin the vehicle 104. The speech can include one or more utterances 170 in a particular natural language (e.g., English, German, Spanish, or Portuguese). In example scenarios where the microphone(s) 130 are digital microphones, the control device 110 can include a transceiver device 210 (FIG. 2A) that can receive the audio signal from the microphone(s) 130. The transceiver device 210 can receive the audio signal formatted according to Automotive Audio Bus or another type of digital audio bus standard. Further, because the speech is uttered outside the vehicle 104 and, in some cases, the microphone(s) 130 are cabin-mounted microphones, the control device 110 can apply a defined amplification and/or equalization to the received audio signal. Such amplification and/or equalization can compensate for attenuation of the audio signal that propagates from outside of the vehicle 104 into the vehicle 104. The signal attenuation can be caused by acoustic dampening resulting from the vehicle 104 having its cabin closed; e.g., doors, windows, and trunk are closed. To compensate for attenuation of the audio signal, the control device 110 can include an amplifier/equalizer module 240 (FIG. 2A).

The control device 110 can then determine if a defined command is present in the speech, within the one or more utterances 170. That is, the control device 110 can detect a voice command (e.g., the defined command) within the utterance(s) 170. For example, the control device 110 detect the defined command at a time (“' that can be after t”. Examples of the defined command include “open the trunk,” “close the trunk,” “open liftgate,” “close liftgate,” “open driver door,” “turn on lights,” “start engine,” and the like. To determine if the one or more utterances 170 include a defined command, the control device 110 can include a command detection module 250 (FIG. 2A) that can analyze the audio signal. Analyzing the audio signal can include applying a model 254 to the audio signal, where the model can be a speech recognition model or a keyword spotting model. In some cases, results of analyzing the audio signal include the defined command. Hence, the control device 110 can determine that the defined command is present in the one or more utterances 170. In other cases, results of analyzing the audio signal do not include the defined command, and thus the control device 110 can determine that the defined command is absent from the one or more utterances 170.

In response to determining that a defined command is present in the speech, within the one or more utterances 170, the control device 110 can cause an actor device 140 to perform an operation corresponding to the defined command. In other words, in response to the defined command being present in the speech, the actor device 140 can execute the defined command conveyed in the speech. Performance of such an operation can change a state of the vehicle 104. For purposes of illustration, such a state refers to a condition of the vehicle that can be represented by a state variable within an onboard processing unit, for example. Simply as an illustration, the command can be “open liftgate” and the actor device 140 can be a lock assembly of a liftgate 180 of the vehicle 104. Additionally, the operation corresponding to the command “open liftgate” can include releasing a lock on the liftgate 180. Thus, in response to the control device 110 detecting the command “open liftgate,” the control device 110 can direct the actor device 140 to open the liftgate. As a practical result, a cargo area of the vehicle 104 can become accessible, and the subject 106 can load the packages 160 into the vehicle 104 in a contactless fashion, using speech. In some cases, as is illustrated in FIG. 2A, the control device 110 can include an action module 270 that can cause multiple actor devices 274 to perform respective operations, each corresponding to a particular defined command. The actor device 140 can be included in the multiple actor devices 274.

Under some conditions, the control device 110 may not cause the actor device 140 to perform the operation corresponding to the defined command. For example, the defined command may be detected at a time of day or location that is not safe to be executed. As such, in some cases, prior to causing the actor device 140 to perform such an operation, the control device 110 (via the action module 270 (FIG. 2A) for example, can determine if an acceptance condition is satisfied and, thus, the vehicle 104 can accept voice commands. An acceptance condition can define a constraint to be satisfied in order for the control device 110, via the action module 270 (FIG. 2A), for example, to cause the actor device 140 to perform an operation corresponding to the defined command. The constraint can be, for example, a temporal constraint (e.g., time of day or a time of week), a location-based constraint (e.g., vehicle is parked in a high-crime area or a poorly lit area), an ambient noise constraint (e.g., noise level exceeds a threshold level), a combination thereof, or similar constraints. In instances that the control device 110 determines that an acceptance condition is satisfied, the control device 110 cause the actor device 140 to perform the operation corresponding to the defined command.

Further, or in some cases, in response to detecting a defined command in speech, within the one or more utterances 170, the control device 110 can validate a voice profile corresponding to the speech prior to causing the actor device 140 to perform the operation corresponding to the defined command. In that way, the control device 110 can permit changing a state of the vehicle 104 (e.g., from closed to open) for a subject 106 that is sanctioned or otherwise whitelisted. To that point, in some cases, the control device 110 can include a voice identification module 260 (FIG. 2A) that can analyze audio signals to categorize the speech as having a valid profile or a non-valid profile. The voice identification module 260 can categorize speech in such a fashion by solving a binary classification task. The voice identification module can be trained using audio signals representative of speech uttered within the cabin of the vehicle 104, during the course of use of the vehicle 104 over a defined period of time, for example. The speech that includes a defined command can be valid when the voice identification module 260 categorizes the speech as having a valid profile. In response to a determination that a voice profile is invalid, the control device 110 avoids directing the actor device 140 to perform the operation corresponding to the defined command. In the alternative, in response to a determination that the voice profile is valid, the control device 110 causes the actor device 140 to perform the operation corresponding to the defined command, as is described herein.

Because voice control in accordance with aspects of this disclosure is based on utterances from outside the cabin of the vehicle 104, speech recognition or keyword spotting may not be feasible in some situations. For example, in cases where ambient noise is elevated, the control device 110 may not proceed with analyzing audio signals. Instead, the control device 110 can implement an exception handling process, e.g., the control device 110 can transition to an inactive state until a state of the vehicle 104 changes. As such, in some implementations, the control device 110 can determine if speech is to be monitored. To that end, the control device 110 can determine if one or more conditions are satisfied. Such condition(s) can be associated with the vehicle 104. In an example scenario, the one or more conditions can be level of ambient noise being less than or equal to a threshold level. The threshold level can be in a range from about70 dB to 90 db. Hence, after determining that an entity (e.g., subject 106) is nearby and approaching the car, the control device 110 can determine if the level of ambient noise within the cabin of the vehicle 104 is less than or equal to the threshold level. For example, the vehicle 104 may be parked next to a construction site, a railroad, or a highway, and thus, ambient noise within the cabin may exceed the threshold level. In addition, or as another example, a pet dog may be barking inside the cabin in response to their caregiver approaching the vehicle 104, and thus, ambient noise within the cabin may exceed the threshold level. In some cases, as is shown in FIG. 2B, the control device 110 can include an ambient noise monitor module 280 that can determine a level of ambient noise based on audio signal received from the microphone(s) 130.

In scenarios where the level ambient noise exceeds the threshold level, the control device 110 can implement an exception handling process. The exception handling process can include, in some cases, causing the control device 110 to transition to a passthrough mode in which audio signal from the microphone(s) 130 can be sent to an infotainment unit without the control device 110 performing any processing on the audio signal. In addition, or in some cases, the exception handling process can include terminating a master role of a node transceiver (Digital Audio Bus node transceiver; e.g., transceiver 210 (FIG. 2A)) included in the control device 110.

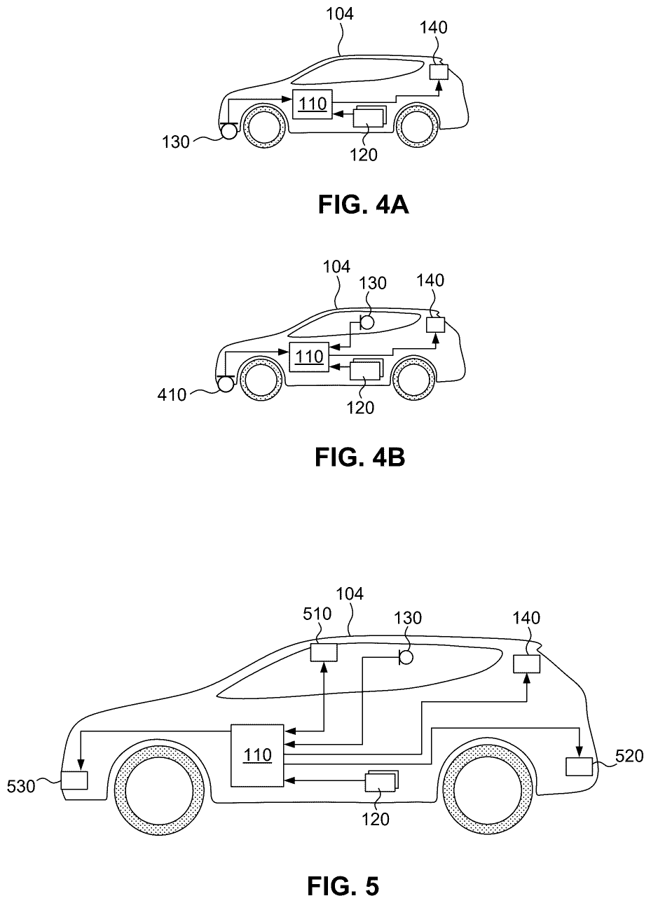

In other scenarios where the level of ambient noise is less than or equal to the threshold level, the control device 110 can perform one or more operations prior to analysis of audio signals. For example, the control device 110 can cause the vehicle 104 to provide an indication that the vehicle 104 is ready to process audio signals indicative of speech and/or receive a voice command. More specifically, the control device 110 can configure a state of the vehicle 104 that is indicative of the vehicle 104 being ready to process audio signals indicative of speech or ready to accept a voice command, or both. In some cases, as is illustrated in FIG. 5, the control device 110 can cause one or more lighting devices of the vehicle 104 to turn on. The lighting device(s) can include, for example, a lighting device 510, a lighting device 520, and/or a lighting device 530. It is noted that the arrangement of the lighting device 510, lighting device 520, and lighting device 530 in the vehicle 104 is schematic and serves as an illustration. The one or more lighting devices of the vehicle 104 can be assembled in one or more locations within the vehicle. In one example, the lighting device 520 can be a turning lighting device, and the control device 110 can cause the lighting device 520 to turn on steadily as opposed to intermittently. Such a differentiated illumination of the turning lighting device can convey that the vehicle 104 is ready to receive and/or accept a voice command. In another example, the lighting device 510 can be an interior lighting device within the cabin of the vehicle 104, and the control device 110 can cause the interior lighting device 510 to turn on. In yet another example, the control device 110 can cause headlight devices and/or position lighting devices to flash according to a defined pattern. The lighting device 530 generically represents the headlight devices and/or position lighting devices.

In addition, or as an alternative, the control device 110 can configure one or more attributes of signal processing involved in the analysis of audio signals from the microphone(s) 130 integrated into the vehicle 104. For example, the control device 110 can cause an amplifier module and/or an equalizer module present in the amplifier/equalizer module 240 (FIG. 2A) to operate according to defined parameters. Example parameters of the defined parameters include amplification gain and equalization (EQ) parameters (such as amplitude, center frequency, and bandwidth) applicable to one or more frequency bands. The amplifier module and the equalizer module can both be programmable, and the control device 110 can configure the amplifier module and/or the equalizer module to operate according to the defined parameters. The control device 110 can determine the defined parameters based on a particular level of ambient noise. Additionally, or in some cases, the control device 110 can determine the defined parameters based on a state signal received from one or more detector devices within the multiple detector devices 120. The state signal can be indicative of the vehicle 104 being open or closed, for example. In situations where the vehicle 104 is open, the control device 110 can disable the amplifier/equalizer module 240 (FIG. 2A).

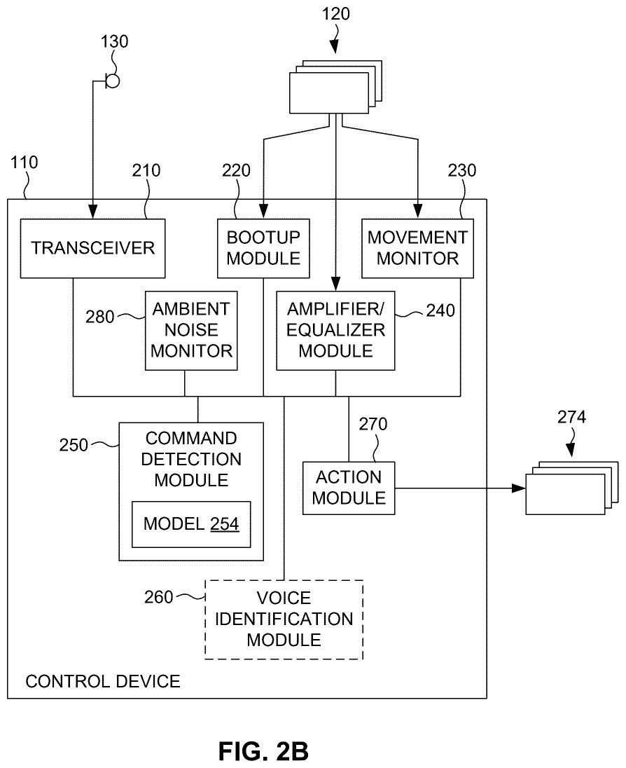

FIG. 3 is a block diagram of another example of the control device 110, in accordance with one or more aspects of this disclosure. As is illustrated in FIG. 3, the control device 110 can include the transceiver 210, multiple input/output (I/O) interfaces 310 (e.g., I/O ports), one or multiple processors 320, and one or multiple memory devices 330 (referred to as memory 330). The memory 330 can include, for example, one or more machine-readable media (transitory and non-transitory) that can be accessed by the processor(s) 320 and/or other component(s) of the control device 110. In one aspect, computer-readable media can comprise computer non-transitory storage media (or computer-readable non-transitory storage media) and communications media. Examples of computer-readable non-transitory storage media include any available media that can be accessed by the control device 110 or any component thereof, including both volatile media and non-volatile media, and removable and/or non-removable media. The memory 330 can include computer-readable media in the form of volatile memory, such as random access memory (RAM), or non-volatile memory, such as read-only memory (ROM), or a combination of both volatile memory and non-volatile memory. In some cases, the processor(s) 320 can be arranged in a single computing apparatus. In other cases, the processor(s) 320 can be distributed across two or more computing apparatuses. The processor(s) 320 can be operatively coupled to the transceiver 210, at least one of the I/O interfaces 310, and the memory 330 via one or several bus architectures, for example.

The memory 330 can retain or otherwise store therein machine-accessible components 340 (e.g., computer-readable and/or computer-executable components) and data 350 in accordance with this disclosure. For example, the data 350 can include various parameters, including first parameters defining respective attributes of signal processing, such as amplifier gain, EQ parameters, and/or second parameters defining threshold levels of ambient noise. The data 350 also can include the model 254 or parameters defining the model 254, and/or data defining one or more acceptance conditions. As such, in some embodiments, machine-accessible instructions (e.g., computer-readable and/or computer-executable instructions) embody or otherwise constitute each one of the machine-accessible components 340 within the memory 330. The machine-accessible instructions can be encoded in the memory 330 and can be arranged to form each one of the machine-accessible components 340. In some cases, the machine-accessible instructions can be built (e.g., linked and compiled) and retained in computer-executable form within the memory 330 or in one or several other machine-accessible non-transitory storage media. Specifically, the machine-accessible components 340 can include the bootup module 220, the movement monitor 230, the ambient noise monitor 280, the amplifier/equalizer module 240, the command detection module 250, and the action module 270. As is described herein, the control device 110 can optionally include the voice identification module 260 and the ambient noise monitor 280. The memory 330 also can include data (not depicted in FIG. 3) that permits various of the functionalities described herein.

The machine-accessible components 340, individually or in a particular combination, can be accessed and executed by at least one of the processor(s) 320. In response to execution, each one of the machine-accessible components 340 can provide the functionality described herein in connection with out-of-cabin voice control of functions of a parked vehicle. Accordingly, execution of the computer-accessible components retained in the memory 330 can cause the control device 110 to operate in accordance with aspects described herein.

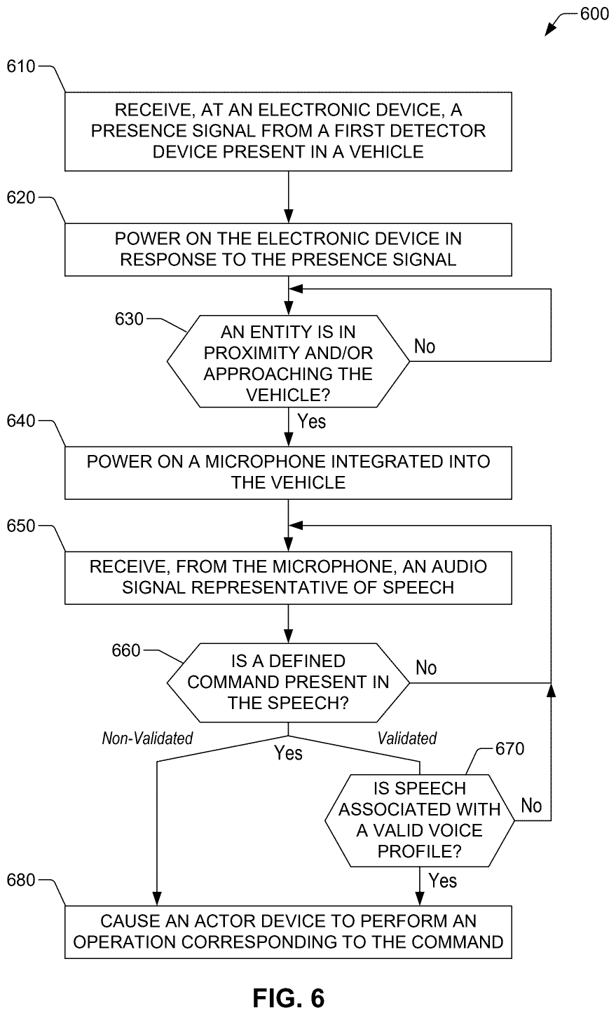

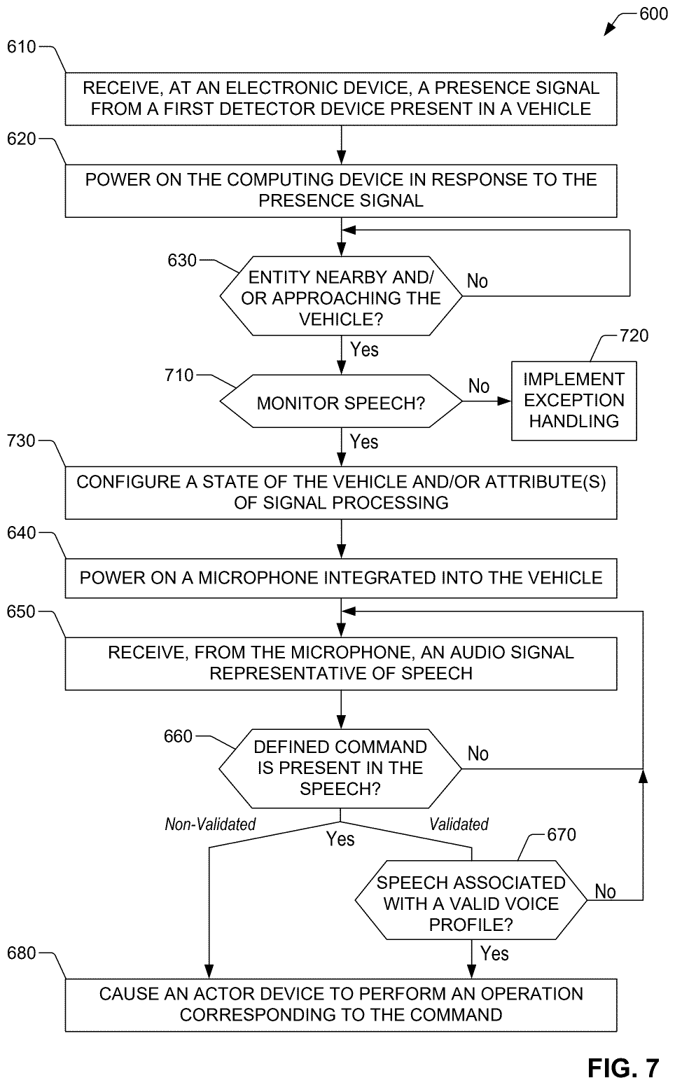

Example methods that can be implemented in accordance with this disclosure can be better appreciated with reference to FIGS. 6-7. For purposes of simplicity of explanation, example methods disclosed herein are presented and described as a series of acts. The example methods are not limited by the order of the acts, as some acts may occur in different orders and/or concurrently with other acts from that shown and described herein. In some cases, one or more example methods disclosed herein can alternatively be represented as a series of interrelated states or events, such as in a state diagram depicting a state machine. In addition, or in other cases, interaction diagram(s) (or process flow(s)) may represent methods in accordance with aspects of this disclosure when different entities enact different portions of the methodologies. It is noted that not all illustrated acts may be required to implement a described example method in accordance with this disclosure. It is also noted that two or more of the disclosed example methods can be implemented in combination with each other, to accomplish one or more functionalities described herein.

FIG. 6 is a flowchart of an example of a method for controlling, using out-of-cabin speech, functions of a vehicle that is parked, in accordance with one or more aspects of this disclosure. In one example, the vehicle can be the vehicle 104 (FIG. 1). An electronic device including computing resources can implement, partially or entirely, the example method 600 illustrated in FIG. 6. The electronic device can be embodied in, or can include, the control device 110 described herein. Accordingly, the electronic device can host a particular combination of two or more of the transceiver 210, the bootup module 220, the movement monitor 230, the amplifier/equalizer module 240, the ambient noise monitor 280, the command detection module 250, the voice identification module 260, and the action module 270.

At block 610, the electronic device (via the bootup module 220, for example) can receive a presence signal from a first detector device present in the vehicle. The first detector device can detect RF signals (e.g., pilot signals) from a hardware token. In one example, the hardware token can be the hardware token 150 (FIG. 1). The first detector device can have a first detection range.

At block 620, the electronic device can power on in response to receiving the presence signal. That is, the presence signal can cause the electronic device to transition from a power-off state to a power-on state. Thus, such a presence signal can be referred to herein as a bootup signal. For example, the bootup module 220 can cause the electronic device to transition from the power-off state to the power-on state in response to the presence signal. The electronic device can be energized by drawing charge from energy storage integrated into the vehicle.

At block 630, the electronic device can determine if an entity (e.g., the subject 106) is in proximity of the vehicle and/or approaching the vehicle. To that end, the electronic device can monitor a signal from a second detector device present in the vehicle. Such a signal may be referred to as a presence signal. The second detector device can have a second detection range that is less than the first detection range. The second detection range can be a distance of about 4 m to about 6 m, for example. Reception, by the electronic device, of signal from the second detector device can be indicative of the entity being at or within the second detection range. Hence, in response to receiving such a signal, the electronic device can determine that the entity is in proximity of the electronic device. In other words, the entity is deemed in proximity to the electronic device in situations where the entity is at or within the second detection range. Conversely, lack of reception of such a signal at the electronic device can be indicative of absence of an entity in proximity and approaching the electronic device.

In response to determining that entity is not proximity of the vehicle and approaching the vehicle, the electronic device can take the “No” branch and the flow of the example method 600 can return to block 630. In the alternative, in response to determining that entity is in proximity of the vehicle and approaching the vehicle, the electronic device can take the “Yes” branch, and the flow of the example method 600 can continue to block 640 where the electronic device can power on a microphone integrated into the vehicle. For example, the electronic device (via the bootup module 220, for example) can cause the microphone integrated into the vehicle to transition from a power-off state to a power-on state in response to the second presence signal. The microphone can be energized by drawing charge from energy storage integrated into the vehicle, for example. Alternatively, in some cases, the microphone(s) 130 may already be in the power-on state and, in those cases, block 640 may not be implemented. The microphone can be present within a cabin of the vehicle or can be assembled facing the exterior of the vehicle. Thus, in one example, the microphone can be one of the microphone(s) 130 (FIG. 1). In another example, the microphone can be one of the microphone(s) 410 (FIG. 4B).

At block 650, the electronic device can receive, from the microphone, an audio signal representative of speech. As is described herein, the speech can be uttered outside the cabin the vehicle.

At block 660, the electronic device can determine if a defined command is present in the speech. To that end, the electronic device, via a speech recognition module, for example, can analyze the audio signal. Analyzing the audio signal can include applying a model to the audio signal, where the model can be a speech recognition model or a keyword spotting model. In some cases, results of analyzing the audio signal include the defined command, and thus, the electronic device can determine that the defined command is present in the speech. In other cases, results of analyzing the audio signal do not include the defined command, and thus the electronic device can determine that the defined command is absent from the speech. As is described herein, examples of the defined command include “open the trunk,” “close the trunk,” “open liftgate,” “close liftgate,” “open driver door,” “turn on lights,” “start engine,” and the like.

In response to determining that the defined command is absent from the speech, the electronic device can take the “No” branch and the flow of the example method 600 can continue to block 650. In response to determining that the defined command is present in the speech, the electronic device can take the “Yes” branch according to two possible implementations. In a first implementation (labeled non-validated) the flow of the example method 600 can continue to block 680 where the electronic device can cause an actor device to perform an operation corresponding to the command. For example, the command can be “open liftgate” and the actor device can be a lock assembly of the liftgate of the vehicle. In that example, the operation can be releasing a lock on the liftgate. In other words, the actor device executes the command conveyed in the speech.

In a second implementation (labeled “Validated” in FIG. 6) the flow of the example method 600 can continue to block 670 where the electronic device can determine if the speech that includes the voice command is associated with a voice profile that is valid. In response to a negative determination, the electronic device can take the “No” branch and the flow of the example method 600 can continue to block 650. In response to a positive determination, the electronic device can take the “Yes” branch and the flow of the example method 600 can continue to block 680.

In some implementations, the example method 600 can include determining if performance of the operation associated with the defined command is permitted. That is, the electronic device can determine if the defined command (or any other defined commands) is accepted. Determining if a defined command is accepted can include determining if an acceptance condition is satisfied. As is described herein, the acceptance condition can be, for example, a temporal condition (e.g., time of day or a time of week), a location-based condition (e.g., vehicle is parked in a low safety area), a combination of both. A positive determination can result in the implementation of the block 680 as is described herein. A negative determination can result in the flow of the example method 600 being directed to block 650, for example. In some cases, absence of visual cue on the vehicle (e.g., a lighting device turned on) can be indicative of defined commands not being accepted.

The performance of the example method 600 has a practical application, which includes permitting contactless voice control of a parked vehicle from the exterior of the vehicle. In some implementations, such a contactless voice control can be afforded to a sanctioned end-user via validation of a voice profile of the end-user. Thus, impermissible control of the vehicle cannot be achieved.

Because voice control is based on utterances from outside the cabin of the vehicle being controlled, speech recognition may not be feasible in some situations. For example, in cases where ambient noise is elevated, the electronic device that implements the example method 600 may not proceed with analyzing audio signals. Accordingly, in some implementations, as is illustrated in FIG. 7, the example method 600 can include a block 710 where the electronic device can determine if speech is to be monitored. To that end, the electronic device can determine if one or more operating conditions are satisfied. More specifically, in some cases, the electronic device can determine if a level of ambient noise within the cabin of the vehicle (e.g., vehicle 104 (FIG. 1)) is less than or equal to a threshold level. The threshold level can be in a range from about 70 dB to 90 db, for example.

In scenarios where the ambient noise exceeds the threshold level, the electronic device can take the “No” branch at block 710 and flow of the example method 600 shown in FIG. 7 can continue to block 720. At that block, the electronic device can implement an exception handling process. The exception handling process can include, for example, causing the electronic device to transition to a passthrough mode in which audio signal from the microphone present in the vehicle can be sent to an infotainment unit without performing any processing on the audio signal. In addition, or in some cases, the exception handling process can include terminating a master role of a transceiver node (Digital Audio Bus node transceiver) integrated into the electronic device.

In scenarios where the ambient noise is less than or equal to the threshold level, the electronic device can take the “Yes” branch at block 710 and flow of the example method 500 shown in FIG. 7 can continue to block 730. At that block, the electronic device can perform one or more operations. For example, the electronic device can cause the vehicle to provide an indication that the vehicle is ready to process audio signals indicative of speech and/or accept a voice command, as is described herein. More specifically, the electronic device can configure a state of the vehicle indicative of the vehicle being ready to process such audio signals. In some cases, the electronic device can cause one or more lighting devices of the vehicle to turn on. In one example, the electronic device can cause a turning lighting device to turn on steadily. In another example, the electronic device can cause an interior lighting device within the cabin to turn on. In yet another example, the electronic device can cause headlight devices and/or position lighting devices to flash according to a defined pattern.

In addition, or as an alternative, at block 730, the electronic device can configure one or more attributes of signal processing involved in the analysis of audio signals from a microphone integrated into the vehicle. For example, the electronic device can cause an amplifier device or an equalizer device, or both, to operate according to defined parameters. Examples of the defined parameters include amplification gain and equalization (EQ) parameters (such as amplitude, center frequency, and bandwidth) applicable to one or more frequency bands. The amplifier device and the equalizer device can both be programmable, and the electronic device can configure the amplifier device and/or the equalizer device to operate according to the defined parameters.

In some cases, as part of block 730, the electronic device can determine, based on at least on one state signal, that a cabin of the vehicle is open. In addition, the electronic device can then configure the one or more attributes of signal processing for audio signal. After such configuration, in response to receiving audio signals, the electronic device can process the audio signal according to the one or more configured attributes.

Numerous other aspects emerge from the foregoing detailed description and annexed drawings. Those aspects are represented by the following Clauses.

Clause 1 includes a method, where the method includes transitioning, in response to a first presence signal, an electronic device from a power-off state to a power-on state while a vehicle is parked, wherein the electronic device is integrated into the vehicle; determining, in response to a second presence signal, that an entity is within a defined range from the vehicle and approaching the vehicle; receiving, by the electronic device, from a microphone integrated into the vehicle, an audio signal representative of speech; determining, by the electronic device, using the audio signal, that a defined command is present in the speech; and causing, by the electronic device, an actor device to perform an operation corresponding to the command, wherein performing the operation causes a change in a state of the vehicle.

A Clause 2 includes Clause 1 and further includes validating a voice profile associated with the speech before the causing the actor device to perform the operation.

A Clause 3 includes any of the preceding Clauses 1 or 2, where the first presence signal is indicative of a hardware token being within a second defined range from the vehicle, the method further comprising receiving, by the electronic device, the first presence signal from a first detector device integrated into the vehicle.

A Clause 4 includes any of the preceding Clauses 1 to 3 and further includes receiving, by the electronic device, the second presence signal from a second detector device integrated into the vehicle.

A Clause 5 includes any of the preceding Clauses 1 to 4 and further includes causing, by the electronic device, a microphone integrated into the vehicle to transition from a second power-off state to a second power-on state in response to the second presence signal.

A Clause 6 includes any of the preceding Clauses 1 to 5 and further includes determining that a level of ambient noise within a cabin of the vehicle is less than a threshold level before the causing the microphone to transition from the second power-off state to the second power-on state.

A Clause 7 includes any of the preceding Clauses 1 to 6 and further includes causing, by the electronic device, the vehicle to provide an indication that the vehicle is ready to accept a voice command.

A Clause 8 includes any of the preceding Clauses 1 to 7, where the causing, by the electronic device, the vehicle to provide the indication comprises causing, by the electronic device, one or more lighting devices integrated into the vehicle to turn on.

A Clause 9 includes any of the preceding Clauses 1 to 8 and further includes determining, based on at least one state signal, that a cabin of the vehicle is open; configuring one or more attributes of signal processing for the audio signal; and processing the audio signal according to the one or more configured attributes.

A Clause 10 includes a device, where the device includes: at least one processor and at least one memory device storing processor-executable instructions that, in response to execution by the at least one processor, cause the device to: transition, in response to a first presence signal from a power-off state to a power-on state while a vehicle is parked, wherein the device is integrated into the vehicle; determine, in response to a second presence signal, that an entity is within a defined range from the vehicle and approaching the vehicle; receive, from a microphone integrated into the vehicle, an audio signal representative of speech; determine, using the audio signal, that a defined command is present in the speech; and cause an actor device to perform an operation corresponding to the command, wherein performing the operation causes a change in a state of the vehicle.

A Clause 11 includes the Clause 10, the at least one memory device storing further processor-executable instructions that, in response to execution by the at least one processor, further cause the device to validate a voice profile associated with the speech before the causing the actor device to perform the operation.

A Clause 12 includes any of the preceding Clauses 10 or 11, where the first presence signal is indicative of a hardware token being within a second defined range from the vehicle.

A Clause 13 includes any of the preceding Clauses 10 to 12, where the second presence signal is received from a second detector device integrated into the vehicle.

A Clause 14 includes any of the preceding Clauses 10 to 13, the at least one memory device storing further processor-executable instructions that, in response to execution by the at least one processor, further cause the device to cause a microphone integrated into the vehicle to transition from a second power-off state to a second power-on state in response to the second presence signal.

A Clause 15 includes any of the preceding Clauses 10 to 14, the at least one memory device storing further processor-executable instructions that, in response to execution by the at least one processor, further cause the device to determine that a level of ambient noise within a cabin of the vehicle is less than a threshold level before causing the microphone to transition from the second power-off state to the second power-on state.

A Clause 16 includes any of the preceding Clauses 10 to 15, the at least one memory device storing further processor-executable instructions that, in response to execution by the at least one processor, further cause the device to cause the vehicle to provide an indication that the vehicle is ready to accept a voice command.

A Clause 17 includes any of the preceding Clauses 10 to 16, where the microphone is assembled inside a cabin of the vehicle or is assembled outside the cabin of the vehicle and faces an exterior of the vehicle.

A Clause 18 includes a vehicle, wherein the vehicle includes an electronic device configured to: transition, in response to a first presence signal from a power-off state to a power-on state while a vehicle is parked, wherein the device is integrated into the vehicle; determine, in response to a second presence signal, that an entity is within a defined range from the vehicle and approaching the vehicle; receive, from a microphone integrated into the vehicle, an audio signal representative of speech; determine, using the audio signal, that a defined command is present in the speech; and cause an actor device to perform an operation corresponding to the command, wherein performing the operation causes a change in a state of the vehicle.

A Clause 19 includes the Clause 18, where the electronic device is further configured to validate a voice profile associated with the speech before the causing the actor device to perform the operation.

A Clause 20 includes any of the preceding Clauses 18 and 19, where the electronic device is further configured to cause the vehicle to provide an indication that the vehicle is ready to accept a voice command.

A Clause 21 includes a machine-readable non-transitory medium having machine-executable instructions encode thereon that, in response to execution by at least one processor in a machine (such the electronic device of any of Clauses 10 to 17), cause the machine to perform the method of any of Clauses 1 to 9.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a machine-readable (e.g., computer-readable) non-transitory storage medium having machine-accessible (e.g., computer-accessible instructions, such as computer-readable and/or computer-executable instructions) such as program code or computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” are utilized herein to mean serving as an instance or illustration. Any aspect or design described herein as an “example” or referred to in connection with a “such as” clause is not necessarily to be construed as preferred or advantageous over other aspects or designs described herein. Rather, use of the terms “example” or “such as” is intended to present concepts in a concrete fashion. The terms “first,” “second,” “third,” and so forth, as used in the claims and description, unless otherwise clear by context, is for clarity only and doesn't necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or a memory device or components comprising the memory. It will be appreciated that the memory components and memory devices described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using standard programming and/or engineering techniques. In addition, various of the aspects disclosed herein also can be implemented by means of program modules or other types of computer program instructions stored in a memory device and executed by a processor, or other combination of hardware and software, or hardware and firmware. Such program modules or computer program instructions can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), blu-ray disc (BD), or similar), smart cards, and flash memory devices (e.g., card, stick, key drive, or similar).

What has been described above includes examples of one or more aspects of the disclosure. It is, of course, not possible to describe every conceivable combination of components or methodologies for purposes of describing these examples, and it can be recognized that many further combinations and permutations of the present aspects are possible. Accordingly, the aspects disclosed and/or claimed herein are intended to embrace all such alterations, modifications and variations that fall within the spirit and scope of the detailed description and the appended claims. Furthermore, to the extent that one or more of the terms “includes,” “including,” “has,” “have,” or “having” is used in either the detailed description or the claims, such term is intended to be inclusive in a manner similar to the term “comprising” as “comprising” is interpreted when employed as a transitional word in a claim.

What is claimed is:

1. A method, comprising:
transitioning, in response to a first presence signal, an electronic device from a power-off state to a power-on state while a vehicle is parked, wherein the electronic device is integrated into the vehicle;
determining, in response to a second presence signal, that an entity is within a defined range from the vehicle and approaching the vehicle;
receiving, by the electronic device, from a microphone integrated into the vehicle, an audio signal representative of speech;
determining, by the electronic device, using the audio signal, that a defined command is present in the speech; and
causing, by the electronic device, an actor device to perform an operation corresponding to the command, wherein performing the operation causes a change in a state of the vehicle.

2. The method of claim 1, further comprising validating a voice profile associated with the speech before the causing the actor device to perform the operation.

3. The method of claim 1, wherein the first presence signal is indicative of a hardware token being within a second defined range from the vehicle, the method further comprising receiving, by the electronic device, the first presence signal from a first detector device integrated into the vehicle.

4. The method of any one of claim 1, further comprising receiving, by the electronic device, the second presence signal from a second detector device integrated into the vehicle.

5. The method of any one of claim 1, further comprising causing, by the electronic device, a microphone integrated into the vehicle to transition from a second power-off state to a second power-on state in response to the second presence signal.

6. The method of claim 5, further comprising determining that a level of ambient noise within a cabin of the vehicle is less than a threshold level before the causing the microphone to transition from the second power-off state to the second power-on state.

7. The method of any one of claim 6, further comprising causing, by the electronic device, the vehicle to provide an indication that the vehicle is ready to accept a voice command.

8. The method of claim 7, wherein the causing, by the electronic device, the vehicle to provide the indication comprises causing, by the electronic device, one or more lighting devices integrated into the vehicle to turn on.

9. The method of any one of claim 1, further comprising:
determining, based on at least one state signal, that a cabin of the vehicle is open;
configuring one or more attributes of signal processing for the audio signal; and
processing the audio signal according to the one or more configured attributes.

10. A device, comprising:
at least one processor; and
at least one memory device storing processor-executable instructions that, in response to execution by the at least one processor, cause the device to:
transition, in response to a first presence signal from a power-off state to a power-on state while a vehicle is parked, wherein the device is integrated into the vehicle;
determine, in response to a second presence signal, that an entity is within a defined range from the vehicle and approaching the vehicle;
receive, from a microphone integrated into the vehicle, an audio signal representative of speech;
determine, using the audio signal, that a defined command is present in the speech; and
cause an actor device to perform an operation corresponding to the command, wherein performing the operation causes a change in a state of the vehicle.

11. The device of claim 10, the at least one memory device storing further processor-executable instructions that, in response to execution by the at least one processor, further cause the device to validate a voice profile associated with the speech before the causing the actor device to perform the operation.

12. The device of claim 10, wherein the first presence signal is indicative of a hardware token being within a second defined range from the vehicle.

13. The device of any one of claim 10, wherein the second presence signal is received from a second detector device integrated into the vehicle.

14. The device of any one of claim 10, the at least one memory device storing further processor-executable instructions that, in response to execution by the at least one processor, further cause the device to cause a microphone integrated into the vehicle to transition from a second power-off state to a second power-on state in response to the second presence signal.

15. The device of claim 14, the at least one memory device storing further processor-executable instructions that, in response to execution by the at least one processor, further cause the device to determine that a level of ambient noise within a cabin of the vehicle is less than a threshold level before causing the microphone to transition from the second power-off state to the second power-on state.

16. The device of any one of claim 15, the at least one memory device storing further processor-executable instructions that, in response to execution by the at least one processor, further cause the device to cause the vehicle to provide an indication that the vehicle is ready to accept a voice command.

17. The device of any one of claim 10, wherein the microphone is assembled inside a cabin of the vehicle or is assembled outside the cabin of the vehicle and faces an exterior of the vehicle.

18. A vehicle, comprising:
an electronic device configured to:
transition, in response to a first presence signal from a power-off state to a power-on state while a vehicle is parked, wherein the device is integrated into the vehicle;
determine, in response to a second presence signal, that an entity is within a defined range from the vehicle and approaching the vehicle;
receive, from a microphone integrated into the vehicle, an audio signal representative of speech;
determine, using the audio signal, that a defined command is present in the speech; and
cause an actor device to perform an operation corresponding to the command, wherein performing the operation causes a change in a state of the vehicle.

19. The vehicle of claim 18, wherein the electronic device is further configured to validate a voice profile associated with the speech before the causing the actor device to perform the operation.

20. The vehicle of claim 19, wherein the electronic device is further configured to cause the vehicle to provide an indication that the vehicle is ready to accept a voice command.
